(19) United States
(12) Patent Application Publication
(10) Pub. No.: US 2006/0019723 A1
(43) Pub. Date: Jan. 26, 2006

(54) Automatic control of power save operation in a portable communication device utilizing historical usage information

(76) Inventors: Pieter Vorenkamp, Laguna Niguel, CA (US); Neil Y. Kim, Laguna Niguel, CA (US); Sumant Ranganathan, Sunnyvale, CA (US); Chun-ying Chen, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 11/166,833

(22) Filed: Jun. 24, 2005

Related U.S. Application Data
(60) Provisional application No. 60/584,087, filed on Jun. 29, 2004.

(51) Int. Cl. H04B 1/38; H04M 11/00

(52) U.S. Cl. 455/574; 455/405

(57) ABSTRACT

A system and method for automatically controlling power save operation of a portable communication system utilizing historical usage information. Various aspects of the present invention may comprise monitoring usage of a portable communication system. A usage monitor module may perform such monitoring. Usage information for the portable communication system may be accumulated. Such usage information may, for example, be stored in a usage information database. A power-save operating profile may be determined based, at least in part, on the accumulated usage information. An operating profile development module may, for example, determine such a power-save operating profile. The portable communication system may be automatically operated in accordance with the determined power-save operating profile. An operation control module may control such automatic operation of the portable communication system.

### CROSS-REFERENCE TO RELATED APPLICATIONS/INCORPORATION BY REFERENCE

This patent application is related to and claims priority from provisional patent application Ser. No. 60/584,087, filed Jun. 29, 2004, and entitled “AUTOMATIC CONTROL OF POWER SAVE OPERATION IN A PORTABLE COMMUNICATION DEVICE UTILIZING HISTORICAL USAGE INFORMATION,” the contents of which are hereby incorporated herein by reference in their entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

Users of portable communication systems utilize the systems differently at different points throughout the day, week, etc. For example, a user may utilize a cellular phone very little in the office but a large amount during the two hours immediately after leaving work. The user may also utilize the portable communication system extremely little in the middle of the night and at moderate levels the hour(s) prior to the workday. Also, for example, a user may utilize a portable email system extensively during the workweek and relatively little on the weekends or holidays. The user may, for example, rarely utilize the portable email system during the middle of the night.

Further, for example, a user may operate the portable communication system in different communication environments at different points throughout the day, week, etc. For example, a user may operate the portable communication system during commuting times in a relatively noisy communication environment with relatively limited available bandwidth. Also for example, a user may operate the portable communication system during typical work hours in a moderately noisy environment with a large number of physical obstacles that interfere with communications. Further for example, a user may operate the portable communication system during the evening hours in a relatively quiet communication environment with a relatively large available bandwidth and relatively few obstacles to efficient communication.

Generally, a portable communication system will operate at a relatively high level of performance during utilization. High performance communication system operation is often commensurate with relatively high power consumption. For example, high performance communication system operation may comprise relatively high transmission power and increased digital signal processing (e.g., for noise cancellation and error correction).

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Various aspects of the present invention provide a system and method for automatically controlling power-save operation of a portable communication system utilizing historical usage information, substantially as shown in and/or described in connection with at least one of the figures, as set forth more completely in the claims. These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 illustrates an exemplary method for automatically controlling portable communication system operation utilizing historical usage information, in accordance with various aspects of the present invention.

FIG. 2 illustrates an exemplary portable communication system power-save operating profile, in accordance with various aspects of the present invention.

FIG. 3 illustrates an exemplary portable communication system power-save operating profile, in accordance with various aspects of the present invention.

FIG. 4 illustrates an exemplary method for automatically controlling portable communication system operation utilizing historical usage information, in accordance with various aspects of the present invention.

FIG. 5 illustrates an exemplary portable communication system implementing automatic operational control utilizing historical usage information, in accordance with various aspects of the present invention.

### DETAILED DESCRIPTION OF THE INVENTION

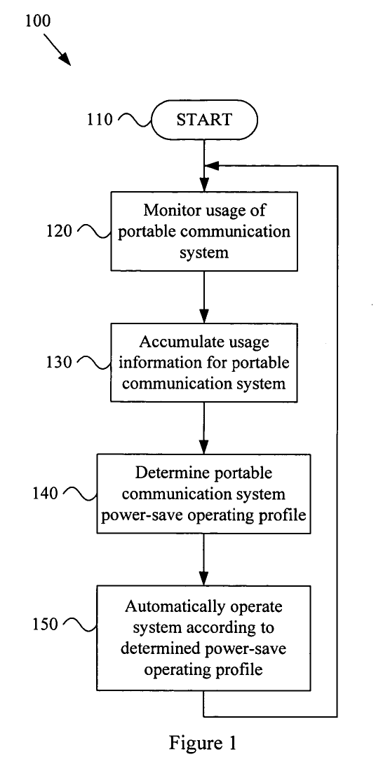

FIG. 1 illustrates an exemplary method 100 for automatically controlling portable communication system operation utilizing historical usage information, in accordance with various aspects of the present invention. For example and without limitation, a portable communication system may comprise a cellular phone, portable email device, or any of a large variety of portable communication systems. Accordingly, the scope of various aspects of the present invention should not be limited by characteristics of a particular type of portable communication system.

The exemplary method 100 may begin at step 110. The exemplary method 100 may begin in response to any of a large variety of causes and conditions. For example and without limitation, the method 100 may begin automatically when the portable communication system is powered up. Alternatively, for example, the method 100 may begin in response to an explicit user command to begin. Accordingly, the scope of various aspects of the present invention should not be limited by characteristics of any particular initiating events or conditions.

The exemplary method 100 may, at step 120, comprise monitoring usage of the portable communication system. Step 120 may, for example, comprise monitoring usage time information. For example, step 120 may comprise monitoring time of day, time of system usage instance, time duration of system usage, time duration of system operation at various performance levels, etc. Step 120 may, for example, comprise monitoring day information. For example, step 120 may comprise monitoring day of the week, date, type of day (e.g., work day, week day or holiday), etc.

A portable communication system may operate at different performance levels at various times. For example, a portable communication system may operate at a relatively high performance level (e.g., relatively high transmission power levels, relatively large amounts of signal encoding/decoding activity, etc.) during various times. Also, for example, a portable communication system may operate at a relatively low performance level (e.g., relatively low transmission power levels, relatively low amounts of signal encoding/decoding activity, etc.) during various times. Such performance levels may result from amounts of available bandwidth, communication path obstacles, noise levels, bit error rate, and various other conditions.

Step 120 may, for example, comprise monitoring performance level information for the portable communication system. For example, step 120 may comprise monitoring system performance level, signal processing level and/or type, transmission power, power utilization, level of encoding and/or decoding, level of noise filtering, communication data rate, etc.

In general, step 120 may comprise monitoring usage of the portable communication system. Accordingly, the scope of various aspects of the present invention should not be limited by characteristics of particular monitored usage characteristics or ways of monitoring such usage characteristics.

The exemplary method 100, at step 130, may comprise accumulating usage information for the portable communication system. For example, such usage information may comprise information of the portable communication system usage monitored at step 120. Also for example, such usage information may comprise information entered by a user or manufacturer of the portable communication system. Step 130 may comprise accumulating usage information for the portable communication system in any of a large variety of manners.

For example and without limitation, step 130 may comprise creating an array or table in memory of usage information. For example, an array or table may comprise information of previously discussed system usage characteristics. As an exemplary illustration, step 130 may comprise forming a multi-dimensional array of time versus usage characteristics. Further for example, step 130 may comprise forming a multi-dimensional array of time, type-of-day and various usage characteristics.

Step 130 may comprise storing accumulated information in any of a variety of manners. For example and without limitation, step 130 may comprise storing accumulated information in a non-volatile memory device. Such a memory device may, for example, be co-located with the portable communication system or located in a distributed network. Such a memory device may, for example, comprise local EEPROM or flash RAM memory.

In general, step 130 may comprise accumulating usage information for the portable communication system. Accordingly, the scope of various aspects of the present invention should not be limited by characteristics of particular usage information or any particular manner of accumulating such usage information.

The exemplary method 100 may, at step 140, comprise determining a power-save operating profile for the portable communication system based, at least in part, on the accumulated usage information of step 130.

The power-save operating profile may, in general, comprise power-save operating information. For example and without limitation, the power-save operating profile may comprise information of power-save operation versus time. Also for example, the power-save operating profile may comprise information of power-save operation versus day. Further for example, the power-save operating profile may comprise information of power-save operation versus time and day.

Information of power-save operation may comprise any of a large variety of information related to power-save operation. For example and without limitation, the information of power-save operation may comprise information of clock characteristics (e.g., clock identification, clock speed, clock variance, clock source, etc.). Also for example, the information of power-save operation may comprise information of power supply characteristics (e.g., power supply voltage or current level, variance, ripple level, noise level, load response, power source identification, etc.).

Further for example, the information of power-save operation may comprise information of one or more fully functional operating levels having different respective performance levels (e.g., high performance, mid performance, low performance, etc.). For example, the information of power-save operation may comprise information of one or more sleeping operating levels having different respective sleep characteristics (e.g., standard sleep level, deep sleep level, power-down, etc.). Such performance and/or sleep levels may, for example, correspond to various system operating parameters (e.g., the power supply and/or clock characteristics discussed previously).

Step 140 may, for example, comprise analyzing the usage information accumulated at step 130 to determine the power-save operating profile. Such analysis may, for example and without limitation, comprise identifying various time windows corresponding to periods of varying respective system utilization levels. For example, such analysis may comprise identifying time (and/or day) windows that correspond to peak usage of the portable communication system. Similarly for example, such analysis may comprise identifying time (and/or day) windows that correspond to relatively high, moderate, low, very low and no usage. Step 140 may then, for example, comprise determining the power-save operating profile based at least in part on such usage level information.

Further for example, step 140 may comprise analyzing usage information accumulated at step 130 to identify various time windows corresponding to respective system performance levels. For example, such analysis may comprise identifying time (and/or day) windows that correspond to high performance system operation. Similarly for example, such analysis may comprise identifying time (and/or day) windows that correspond to peak, relatively high, moderate, low or very low performance system operation. Step 140 may then, for example, comprise determining the power-save operating profile based at least in part on such performance level information.

Though the previous exemplary illustrations refer to time windows and discrete levels of usage and performance, it should be noted that the analyzed usage information and/or the power-save operating profile may be substantially continuous, versus having discrete levels. For example, resolution between time windows, usage characteristics, performance characteristics, system operating parameters and etc. may be substantially continuous (e.g., limited by quantization associated with digital representation of information).

Step 140, in determining a power-save operating profile for the portable communication system may also, for example, comprise receiving operating instructions from a user and basing the power-save operating profile, at least in part, on such received operating instructions. For example and without limitation, a user may input operating instructions to mandate particular operating characteristics for a time period. For example, a user may provide operating instructions to indicate that the portable communication system is to operate at peak performance at all times, at all times for a particular day, according to a weekend power-save operating profile during a vacation day, or according to a work day profile when working on the weekend. In one exemplary scenario, step 140 may, for example, comprise incorporating such operating instructions into a power-save operating profile.

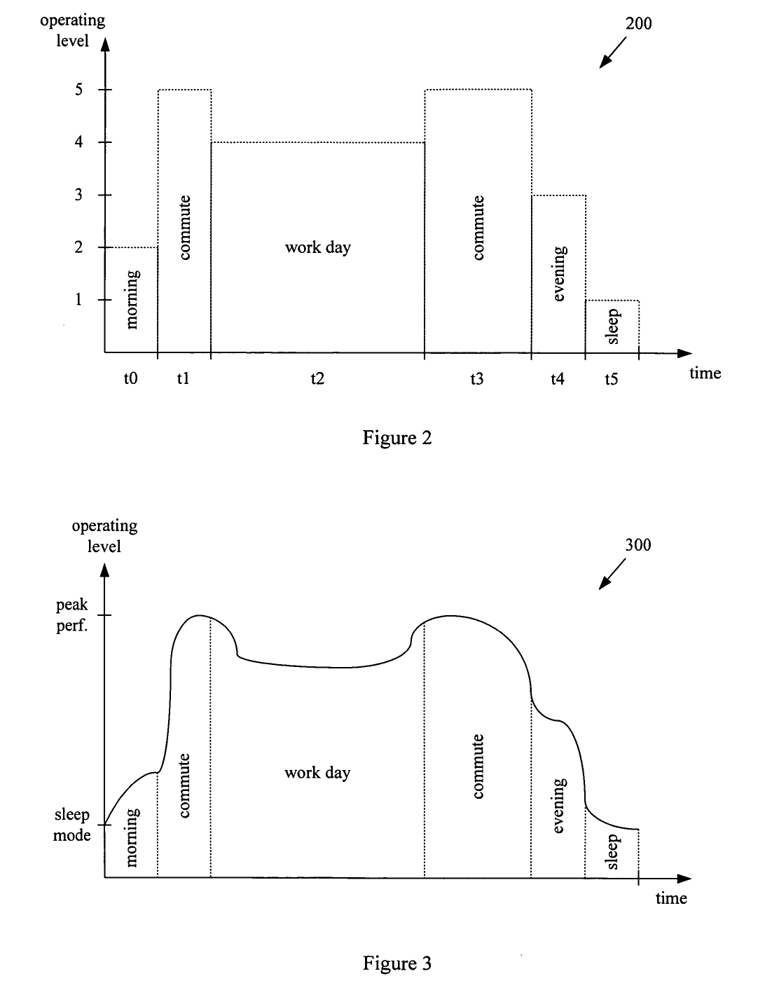

Referring now to FIG. 2, an exemplary portable communication system power-save operating profile 200, in accordance with various aspects of the present invention, is illustrated. The exemplary power-save operating profile 200 corresponds to power-save operation for the portable communication system for a typical workday. Such a power-save operating profile 200 may, for example, have been determined at step 140 of the exemplary method 100 illustrated in FIG. 1 and discussed previously. Such a power-save operating profile 200 may, for example, have been determined based at least in part on accumulated usage information for the portable communication system.

The exemplary operating profile 200 shows an operating day divided into six discrete time windows t₀-t₅. The time windows may, for example, correspond respectively to sections of a work day categorized as pre-work morning time, time commuting to work, time at work, time commuting home from work, evening time and sleep time. The exemplary operating profile 200 shows five discrete operating levels 1-5. The operating levels may, for example, correspond respectively to sleep mode, low performance, medium performance, high performance and peak performance.

It should be stressed that the exemplary power-save operating profile 200 provides one exemplary illustration of a large number of power-save profile types. A power-save profile may, for example and without limitation, comprise any number of dimensions and/or operating levels. Accordingly, the scope of various aspects of the present invention should not be limited by characteristics of the exemplary power-save operating profile 200.

Referring now to FIG. 3, an exemplary portable communication system power-save operating profile 300, in accordance with various aspects of the present invention, is illustrated. The exemplary power-save operating profile 300 may, for example, correspond to power-save operation for the portable communication system for a typical workday. Such a power-save operating profile 300 may, for example, have been determined at step 140 of the exemplary method 100 illustrated in FIG. 1 and discussed previously. Such a power-save operating profile 300 may, for example, have been determined based at least in part on accumulated usage information for the portable communication system.

Comparing the exemplary power-save operating profile 300 to the exemplary power-save operating profile 200 illustrated in FIG. 2, the exemplary power-save operating profile 300. is generally a continuous-time and continuous-operating-level version of the exemplary power-save operating profile 200 illustrated in FIG. 2. In other words, the exemplary power-save operating profile 300 has a substantially infinite number of times and power-save operating levels (e.g., which may be subject to quantization in a digital system).

It should be stressed that the exemplary power-save operating profile 300 provides one exemplary illustration of a large number of potential power-save operating profile types. A power-save profile may, for example and without limitation, comprise any number of dimensions and/or operating characteristics. Accordingly, the scope of various aspects of the present invention should not be limited by characteristics of the exemplary power-save operating profile 300.

Referring back to FIG. 1, step 140 may generally comprise determining a power-save operating profile for the portable communication system based, at least in part, on the usage information accumulated at step 130. Accordingly, the scope of various aspects of the present invention should not be limited by characteristics of particular power-save operating profiles or by characteristics of particular ways of determining a power-save operating profile.

The exemplary method 100 may, at step 150, comprise automatically operating the portable communication system in accordance with the determined power-save operating profile. For example, step 150 may comprise operating the portable communication system in accordance with various operating levels specified in the power-save operating profile determined at step 140.

For example and without limitation, step 150 may comprise operating the portable communication system at a peak performance level by providing various components of the portable communication system with a maximum clock speed and/or with electrical power having optimal power supply characteristics. Also for example, step 150 may comprise operating the portable communication system at a relatively high performance level by providing various components of the portable communication system with a relatively high clock speed (e.g., 90% of the maximum clock speed) and a relatively high quality power supply (e.g., power supply characteristics within 5% of optimal power supply characteristics). Additionally, for example, step 150 may comprise operating the portable communication system at or above a relatively high Power Supply Rejection Ratio (“PSRR”) (e.g., approximately 70 dB).

Further for example, step 150 may comprise operating the portable communication system at a relatively low but fully-functional (i.e., non-sleeping) level by providing various components of the portable communication system with a relatively low clock speed (e.g., 40% of maximum clock speed) and/or with electrical power having substantially sub-optimal characteristics (e.g., power supply characteristics within 25% of optimal power supply characteristics). Additionally, for example, step 150 may comprise operating the portable communication system at or below a relatively low PSRR (e.g., approximately 40 dB).At such a low performance level, the portable communication system may, for example, utilize significantly less energy to operate than at relatively higher performance levels.

Also for example, step 150 may comprise operating the portable communication system in one or more levels of sleep mode in accordance with the determined power-save operating profile. For example and without limitation, step 150 may comprise operating the portable communication system in a first sleep mode in which a first portion of system components are operated in a sleep state for a first period of time. Step 150 may also, for example, comprise operating the portable communication system in a second sleep mode in which a second portion of system components are operated in a sleep state for a second period of time.

Note that operating the portable communication system at various performance levels may comprise controlling any of a large number of system operating characteristics. Accordingly, the scope of various aspects of the present invention should not be limited by particular system operating characteristics (e.g., clock speed and/or power supply and/or sleep mode characteristics).

In an exemplary scenario, step 150 may comprise operating the portable communication system at a relatively high performance level in accordance with a first portion of the power-save operating profile, and operating the portable communication system at a relatively low performance level in accordance with a second portion of the power-save operating profile. Referring to the exemplary power-save operating profile 200 illustrated in FIG. 2, step 150 may comprise operating the portable communication system at a relatively high performance level during time period t₁, and operating the portable communication system at a relatively low performance level during time period t₀.

In another exemplary scenario, step 150 may comprise operating the portable communication system at a fully functional (i.e., non-sleeping) performance level in accordance with a first portion of the power-save operating profile, and operating the portable communication system in a sleep mode in accordance with a second portion of the power-save operating profile. Referring to the exemplary power-save operating profile 200 illustrated in FIG. 2, step 150 may comprise operating the portable communication system at a fully functional performance level during time period t₄, and operating the portable communication system in a sleep mode during time period t₅.

In another exemplary scenario, step 150 may comprise operating the portable communication system at a fully functional and relatively high performance level in accordance with a first portion of the power-save operating profile, and operating the portable communication system at a fully-functional and relatively low performance level in accordance with a second portion of the power-save operating profile. Referring to the exemplary power-save operating profile 200 illustrated in FIG. 2, step 150 may comprise operating the portable communication system at a fully functional and relatively high performance level during time period t₂, and operating the portable communication system at a fully functional and relatively low performance level during time period t₀.

In yet another exemplary scenario, step 150 may comprise providing a supply of power with first power supply characteristics to one or more components of the portable communication system in accordance with a first portion of the power-save operating profile, and providing a supply of power with second power supply characteristics to one or more components of the portable communication system in accordance with a second portion of the power-save operating profile, the first and second power supply characteristics being different. Referring to the exemplary power-save operating profile 200 illustrated in FIG. 2, step 150 may comprise providing a supply of power with first power supply characteristics to one or more components of the portable communication system during time period t₀, and providing a supply of power with second power supply characteristics (e.g., optimal power supply characteristics for peak performance) to one or more components of the portable communication system during time period t₁.

In a further exemplary scenario, step 150 may comprise utilizing a first clock signal to drive one or more components of the portable communication system in accordance with a first portion of the power-save operating profile, and utilizing a second clock signal to drive the one or more components in accordance with a second portion of the power-save operating profile, the first and second clock signals having different respective clock characteristics. Referring to the exemplary power-save operating profile 200 illustrated in FIG. 2, step 150 may comprise utilizing a first clock signal to drive one or more components of the portable communication system during time period t₀, and utilizing a second clock signal (e.g., characterized by maximum performance clock characteristics) to drive the one or more components of the portable communication system during time period t₁.

In automatically operating the portable communication system in accordance with the determined power-save operating profile, step 150 may also comprise receiving indications of various real-time events and/or conditions, and responding to such indications by adjusting the operating level of the portable communication system. Such real-time events and/or conditions may, for example and without limitation, comprise an input from a user, dynamic communication environmental conditions, an unexpected burst of usage during a typically low usage period, etc.

In automatically operating the portable communication system in accordance with the determined power-save operating profile, step 150 may also, for example, comprise receiving operating instructions from a user and adjusting the operating level of the portable communication system based, at least in part, on such received operating instructions. For example and without limitation, a user may input operating instructions to mandate particular operating characteristics for a time period, thereby overriding the power-save operating profile. For example, a user may provide operating instructions to indicate that the portable communication system is to operate at peak performance for a period of time or until the user specifies otherwise. Step 150 may, for example, comprise modifying the operating level in accordance with such received operating instructions.

In automatically operating the portable communication system in accordance with the determined power-save operating profile, step 150 may also comprise interacting with various other operational control components of the portable communication system. For example and without limitation, step 150 may comprise interacting with various system components that may control general sleep mode functionality.

The exemplary method 100 illustrated in FIG. 1 and discussed previously, and exemplary power-save operating profiles 200, 300 illustrated in FIGS. 2-3 and discussed previously, are merely exemplary, and were presented to provide specific examples of various broader aspects of the present invention. Accordingly, the scope of various aspects of the present invention should not be limited by characteristics of the exemplary method 100 and power-save operating profiles 200, 300.

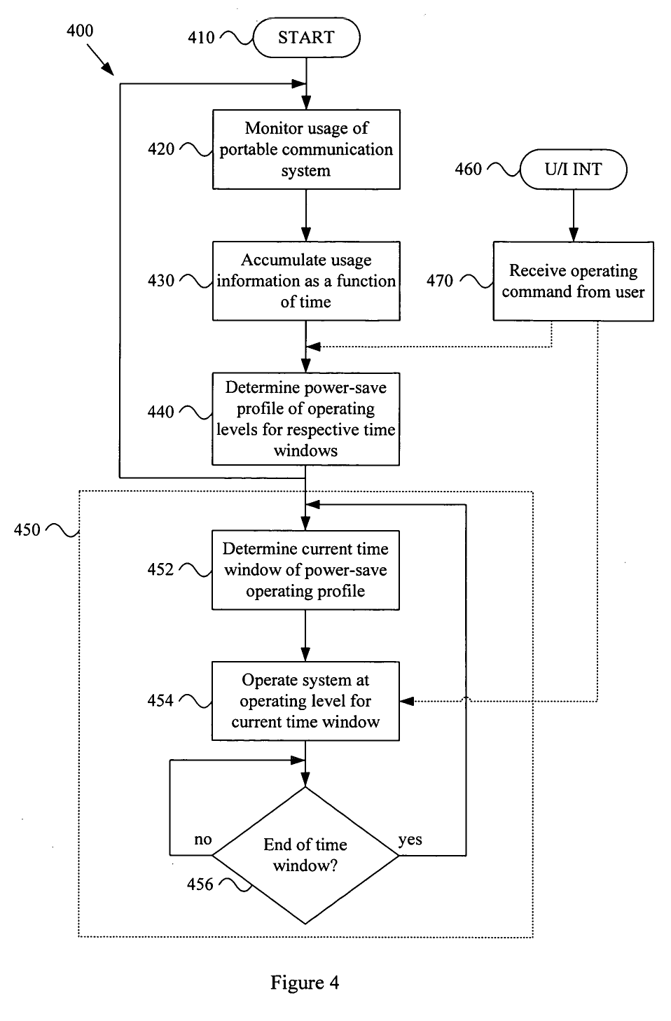

FIG. 4 illustrates an exemplary method 400 for automatically controlling portable communication system operation utilizing historical usage information, in accordance with various aspects of the present invention. Various aspects of the exemplary method 400 may share characteristics with various aspects of the exemplary method 100 illustrated in FIG. 1 and discussed previously.

The exemplary method 400 may begin at step 410. The exemplary method 400 may begin in response to any of a large variety of causes and conditions. For example and without limitation, the method 400 may begin automatically when the portable communication system is powered up. Alternatively, for example, the method 400 may begin in response to an explicit user command to begin. Accordingly, the scope of various aspects of the present invention should not be limited by characteristics of any particular initiating events or conditions.

The exemplary method 400 may, at step 420, comprise monitoring usage of the portable communication system. Step 420 may, for example and without limitation, share various characteristics with step 120 of the exemplary method 100 illustrated in FIG. 1 and discussed previously. For example, step 420 may comprise monitoring usage information and time information.

The exemplary method 400 may, at step 430, comprise accumulating usage information for the portable communication system. Step 430 may, for example and without limitation, share various characteristics with step 130 of the exemplary method 100 illustrated in FIG. 1 and discussed previously. For example, step 430 may comprise accumulating usage information as a function of time.

The exemplary method 400 may, at step 440, comprise determining a power-save operating profile for the portable communication system based, at least in part, on the accumulated usage information from step 430. Step 440 may, for example and without limitation share various characteristics with step 140 of the exemplary method 100 illustrated in FIG. 1 and discussed previously. For example, step 440 may comprise determining a power-save operating profile comprising power-save operating levels for respective time windows.

In the exemplary method 400, method flow may comprise multiple flow loops. For example, method 400 execution may flow in a first loop from step 440 back to step 420. In this exemplary method flow loop, the exemplary method 400 may, through steps 420-440, continually monitor usage of the portable communication system, accumulating usage information, and determining power-save operating profile characteristics.

Method flow may also continue from step 440 to step 450 for operating the portable communication system. Accordingly, the exemplary method 400 may comprise monitoring and controlling operation of the portable communication system simultaneously. Such simultaneous operation may, for example, be accomplished through the use of parallel processing or time-shared processing.

The exemplary method 400 may, at step 450, comprise automatically operating the portable communication system in accordance with the determined power-save operating profile. Step 450 may, for example and without limitation share various characteristics with step 150 of the exemplary method 100 illustrated in FIG. 1 and discussed previously. For example, step 450 may comprise exemplary steps 452-456, to be discussed below. However, it is emphasized that exemplary steps 452-456 are merely exemplary and should by no means limit the scope of various aspects of the present invention.

The exemplary method 400 may, at step 452, comprise determining a current time window of the power-save operating profile determined at step 440. For example, step 452 may comprise determining the current time (e.g., current time of day, day, date, etc.) and determining which time window of the power-save operating profile corresponds to the current time.

The exemplary method 400 may, at step 454, comprise operating the portable communication system in accordance with an operating level corresponding to the current time window. For example, step 454 may utilize the current time window determination of step 452 to determine an operating level corresponding to the current time window. Step 454 may then, for example, operate the portable communication system in accordance with the operating level. For example, an operating level may correspond to particular power-save operating characteristics (e.g., clock characteristics, power supply characteristics, sleep mode characteristics, etc.).

The exemplary method 400 may, at step 456, comprise determining if the end of the current time window has been reached. If the end of the current time window has been reached, then method 400 flow may loop back to step 452 for determining the next time window and continuing operation from there. If the end of the current time window has not been reach, then method 400 flow may loop back to step 456 to wait for the end of the current time window to be reached.

For example and without limitation, as discussed previously, an exemplary power-save operating profile 200 is illustrated in FIG. 2. In an exemplary scenario, step 452 may determine that the current time is within the t₁ time window of the power-save operating profile 200. Step 454 may determine that operating level 5 corresponds to the t₁ time window and may determine operating characteristics for the portable communication system that correspond to operating level 5. For example, step 454 may determine that operating level 5 corresponds to the peak operating level for the portable communication system, where the peak operating level is characterized by maximum clock speed and optimal power supply characteristics for processing speed. Step 454 may then comprise operating the portable communication system according to the determined operating characteristics.

Continuing the exemplary scenario, step 456 may analyze the current time and the current time window until the current time no longer corresponds to the current time window. When the current time no longer corresponds to the current time window, step 456 may direct method flow back to step 452 to determine the next time window, which in the exemplary illustration is t₂. Step 454 may then, for example, analyze the power-save operating profile to determine that operating level 4 corresponds to time window t₂, and operate the portable communication system in accordance with the operating characteristics associated with operating level 4. Such operation may continue until step 456 determines that the current time no longer corresponds with time window t₂, and the operating cycle continues.

As mentioned previously, in the exemplary method 400, method flow may comprise multiple flow loops. For example, method 400 execution may flow in a second loop through steps 452-456. In this exemplary method flow loop, the exemplary method 400 may, through steps 452-456, continually control operation of the portable communication system, in accordance with the power-save operating profile developed in the first method 400 flow loop, discussed previously.

The exemplary method 400, at step 460, may comprise receiving a user interface interrupt. Such an interrupt may, for example and without limitation, result from a user expressing a desire to input an operating command to the portable communication system. The exemplary method 400, at step 470, may then comprise receiving the operating command from the user.

In an exemplary scenario, the operating command may comprise a command to alter the power-save operating profile. In such an exemplary scenario, the exemplary method 400 may flow to step 440, which may incorporate aspects of the operating command into the determined power-save operating profile.

In another exemplary scenario, the operating command may comprise a command to temporarily override a portion of the power-save operating profile (i.e., operate the portable communication system in a particular manner regardless of the power-save operating profile). Such an override may, for example, be for a specified time duration or an indefinite period. In such an exemplary scenario, the exemplary method 400 may flow to step 454, which may adjust operating behavior for the portable communication system in accordance with the operating command.

It should again be stressed that the exemplary method 400 illustrated in FIG. 4 and discussed previously is merely exemplary, and should by no means limit the scope of various aspects of the present invention to characteristics of the exemplary method 400.

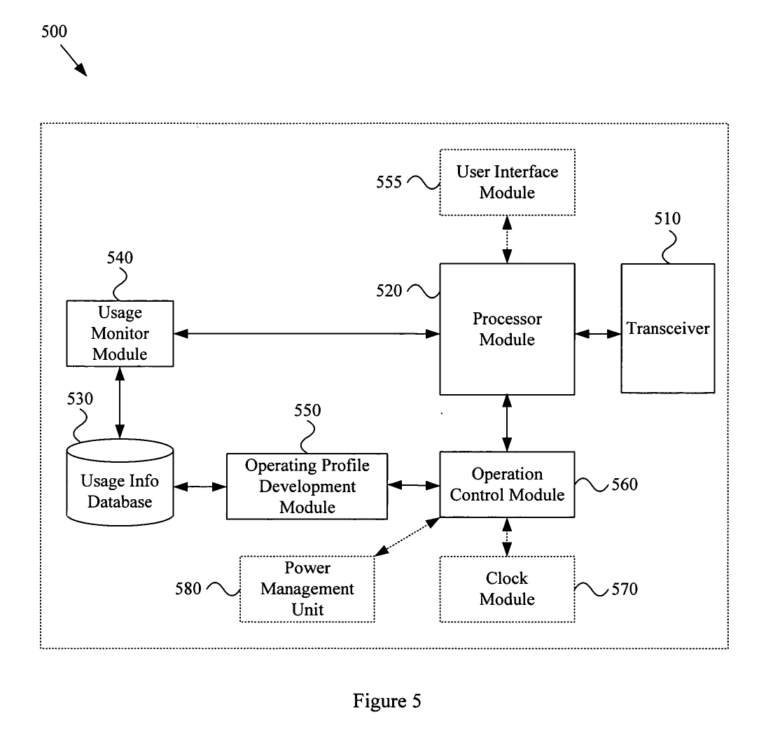

FIG. 5 illustrates an exemplary portable communication system 500 implementing automatic power-save operational control utilizing historical usage information, in accordance with various aspects of the present invention. Various components of the exemplary system 500 may, for example and without limitation, perform the functionality of the exemplary methods 100, 400 illustrated in FIGS. 1 and 4, and discussed previously. For example, the portable communication system 500 may comprise characteristics of a cellular phone, portable email device, two-way radio, or any of a large variety of portable communication systems. Accordingly, the scope of various aspects of the present invention should not be limited by characteristics of a particular type of portable communication system.

The exemplary portable communication system 500 may comprise a transceiver 510 (or transmitter or receiver) to utilize in communication with other communication systems. Such other communication systems may, for example, comprise other portable communication systems, base stations, network access points, etc. The exemplary transceiver 510 may communicate with other communication systems using any of a large variety of communication media and/or protocols. For example and without limitation, the exemplary transceiver 510 may communicate with other communication systems using a wired or wireless communication link. The communication medium may, for example, comprise an electrical, RF and/or optical medium. Accordingly, the scope of various aspects of the present invention should not be limited by characteristics of a particular transceiver, communication medium and/or protocol.

The exemplary portable communication system 500 may comprise a processor module 520 that performs various processing activities of the system 500. The processor module 520 may, for example and without limitation, comprise the central controller of the portable communication system. The processor module 520 may perform any of a large variety of processing activities, including interfacing with various system devices not illustrated in FIG. 5.

The exemplary portable communication system 500 may comprise a usage information database 530. The usage information database 530 may, for example, store various information utilized by modules of the system 500 that perform activities related to controlling the power-save operation of the portable communication system 500.

The usage information database 530 may comprise any of a large variety of database characteristics. For example and without limitation, the usage information database 530 may be utilized to perform various functions of the exemplary methods 100, 400 (e.g., steps 130 and 430) illustrated in FIGS. 1 and 4, and discussed previously.

For example, the usage information database 530 may comprise a local or distributed memory architecture. The usage information database 530 may comprise volatile or non-volatile memory. The usage information database 530 may be formatted and/or architected according to any of a large variety of database configurations. In general, the usage information database 530 may store information related to power-save operation of the portable communication system 500. Accordingly, the scope of various aspects of the present invention should not be limited by characteristics of a particular database, memory device, memory architecture, memory strategy, etc.

The exemplary portable communication system 500 may comprise a usage monitor module 540 that monitors usage of the portable communication system. For example and without limitation, the usage monitor module 540 may perform various functions of the exemplary methods 100, 400 (e.g., steps 120 and 420) illustrated in FIGS. 1 and 4, and discussed previously. The usage monitor module 540 may, for example, store usage information related to the monitored usage in the usage information database 530.

The usage monitor module 540 may, for example, monitor usage of the portable communication system 500. The usage monitor module 540 may, for example, monitor usage time information. For example, the usage monitor module 540 may monitor time of day, time of system 500 usage instance, time duration of system 500 usage, time duration of system 500 operation at various performance levels, etc. The usage monitor module 540, for example, monitor day information. For example, the usage monitor module 540 may monitor day of the week, date, type of day (e.g., work day, week day or holiday), etc. The usage monitor module 540, for example, monitor instances of system 500 usage. The usage monitor module 540 may, for example, monitor operating characteristics for the portable communication system 500. For example, the usage monitor module 540 may monitor system 500 performance level, signal processing level and/or type, transmission power, power utilization, level of encoding and/or decoding, level of noise filtering, communication data rate, etc.

In general, the usage monitor module 540 may monitor any of a large variety of usage characteristics of the portable communication system 500. Accordingly, the scope of various aspects of the present invention should not be limited by characteristics of particular monitored usage characteristics or apparatus for monitoring such usage characteristics.

The usage monitor module 540 may, for example, store usage information for the portable communication system 500 in the usage information database 530. Such usage information may comprise information of usage characteristics monitored by the usage monitor module 540. Various exemplary characteristics of the usage information database 530 were discussed previously.

For example and without limitation, the usage monitor module 540 may create and/or manage an array or table of usage information in the usage information database 530. For example, an array or table may comprise information of previously discussed system usage characteristics. As an exemplary illustration, the usage monitor module 540 (e.g., in conjunction with the usage information database 530) may create and/or manage a multi-dimensional array of time versus usage characteristics. Further for example, the usage monitor module 540 (e.g., in conjunction with the usage information database 530) may comprise forming a multi-dimensional array of time, type-of-day and various usage characteristics.

In general, the usage monitor module 540 may store usage information for the portable communication system in the usage information database 530. Accordingly, the scope of various aspects of the present invention should not be limited by characteristics of particular usage information or any particular manner of accumulating or storing such usage information.

The exemplary portable communication system 500 may comprise an operating profile development module 550 that processes the portable communication usage information (e.g., as stored in the usage information database 530) to determine a power-save operating profile. The operating profile development module 550 may, for example and without limitation, perform various functionality of the exemplary methods 100, 400 (e.g., steps 140 and 240) illustrated in FIGS. 1 and 4, and discussed previously.

The power-save operating profile may, in general, comprise power-save operating information. The power-save operating profile was generally discussed previously with regard to the exemplary methods 100, 400 illustrated in FIGS. 1 and 4 and discussed previously. Non-limiting exemplary illustrations 200, 300 of two of a large variety of types of power-save operating profiles were also presented previously.

The operating profile development module 550 may, for example, analyze the system usage information (e.g., as accumulated by the usage monitor module 540 and stored in the usage information database 530) to determine the power-save operating profile. Such analysis may, for example and without limitation, comprise identifying various time windows corresponding to periods of varying respective system 500 utilization levels. For example, such analysis may comprise identifying time (and/or day) windows that correspond to peak usage of the portable communication system 500. Similarly for example, such analysis may comprise identifying time (and/or day) windows that correspond to relatively high, moderate, low, very low and no usage. The operating profile development module 550 may then, for example, determine the power-save operating profile based at least in part on such usage level information.

Further for example, the operating profile development module 550 may analyze usage information (e.g., as accumulated by the usage monitor module 540 and stored in the usage information database 530) to identify various time windows corresponding to respective system 500 performance levels. For example, such analysis may comprise identifying time (and/or day) windows that correspond to high performance system 500 operation. Similarly for example, such analysis may comprise identifying time (and/or day) windows that correspond to peak, relatively high, moderate, low or very low performance operation. The operating profile development module 550 may then, for example, determine the power-save operating profile based at least in part on such performance level information.

Though the previous exemplary illustrations refer to time windows and discrete levels of usage and performance, it should be noted that the analyzed usage information and/or the power-save operating profile may be substantially continuous, versus having discrete levels. For example, resolution between time windows, usage characteristics, performance characteristics, system operating parameters and etc. may be substantially continuous (e.g., limited by quantization associated with digital representation of information).

The exemplary portable communication system 500 may comprise a user interface module 555, through which the system 500 may communicate information with a user. For example, a user may communicate operating instructions for the system 500 to the system 500 (e.g., to the processor module 520) through the user interface module 555. Such operating instructions may, for example, comprise instructions to mandate particular system 500 operating characteristics for a time period. For example, a user may provide operating instructions to indicate that the portable communication system 500 is to operate at peak performance at all times, at a medium level of performance at all times for a particular day, according to a weekend power-save operating profile during a vacation day, or according to a work day profile when working on the weekend. In an exemplary scenario, the operating profile development module 550 may incorporate such operating instructions into a power-save operating profile.

In general, the operating profile development module 550 may generally determine a power-save operating profile for the portable communication system based, at least in part, on system usage information (e.g., as determined by the usage monitor module 540 and stored in the usage information database 530). Accordingly, the scope of various aspects of the present invention should not be limited by characteristics of particular power-save operating profiles or by characteristics of particular ways or apparatus for determining a power-save operating profile.

The exemplary portable communication system 500 may comprise an operation control module 560. The exemplary operation control module 560 may, for example, control operation of the portable communication system based, at least in part, on the power-save operating profile developed by the operating profile development module 550. The operation control module 560 may, for example and without limitation, perform various functionality of the exemplary methods 100, 400 (e.g., steps 150 and 250) illustrated in FIGS. 1 and 4, and discussed previously.

For example and without limitation, the operation control module 560 may operate the portable communication system 500 at a peak performance level by providing various components of the portable communication system 500 with a maximum clock speed. The exemplary portable communication system 500 may, for example, comprise a clock module 570 that is communicatively coupled to the operation control module 560. The operation control module 560 may, for example, communicate with the clock module 570 to direct one or more clock signals of varying characteristics (e.g., clock speed) to various components of the system 500.

Also for example, the operation control module 560 may operate the portable communication system 500 at a peak performance level by providing various components of the portable communication system 500 with optimal power supply characteristics for peak performance. The exemplary portable communication system 500 may, for example, comprise a power management unit 580 that is communicatively coupled to the operation control module 560. The operation control module 560 may, for example, communicate with the power management unit 580 to direct one or more supplies of power of varying characteristics (e.g., optimal performance characteristics) to various components of the system 500.

Also for example, the operation control module 560 may (e.g., by communicating with the clock module 570 and/or the power management unit. 580) operate the portable communication system 500 at a relatively high performance by providing various components of the portable communication system 500 with a relatively high clock speed (e.g., 90% of the maximum clock speed) and a relatively high quality power supply (e.g., power supply characteristics within 5% of optimal power supply characteristics).

Further for example, the operation control module 560 may (e.g., by communicating with the clock module 570 and/or the power management unit 580) operate the portable communication system 500 at a relatively low but fully-functional (i.e., non-sleeping) level by providing various components of the portable communication system 500 with a relatively low clock speed (e.g., 40% of maximum clock speed) and/or with electrical power having substantially sub-optimal characteristics (e.g., power supply characteristics within 25% of optimal power supply characteristics). At such a low performance level, the portable communication system 500 may, for example, utilize significantly less energy to operate than at relatively higher performance levels.

Also for example, the operation control module 560 may (e.g., by communicating with the clock module 570 and/or the power management unit 580) operate the portable communication system 500 in one or more levels of sleep mode in accordance with the determined power-save operating profile. For example and without limitation, the operation control module 560 may operate the portable communication system 500 in a first sleep mode in which a first portion of system 500 components are operated in a sleep state for a first period of time. The operation control module 560 may also, for example, operate the portable communication system 500 in a second sleep mode in which a second portion of system 500 components are operated in a sleep state for a second period of time.

Note that operating the portable communication system 500 at various performance levels may comprise controlling any of a large number of system operating characteristics. Accordingly, the scope of various aspects of the present invention should not be limited by characteristics of particular controllable system aspects (e.g., clock speed and/or power supply and/or sleep mode characteristics).

In an exemplary scenario, the operation control module 560 may operate the portable communication system 500 at a relatively high performance level in accordance with a first portion of the power-save operating profile, and operate the portable communication system 500 at a relatively low performance level in accordance with a second portion of the power-save operating profile. Referring to the exemplary power-save operating profile 200 illustrated in FIG. 2, the operation control module 560 may operate the portable communication system at a relatively high performance level during time period t₁, and operate the portable communication system 500 at a relatively low performance level during time period t₀.

In another exemplary scenario, the operation control module 560 may operate the portable communication system 500 at a fully-functional (ie., non-sleeping) performance level in accordance with a first portion of the power-save operating profile, and operate the portable communication system 500 in a sleep mode in accordance with a second portion of the power-save operating profile. Referring to the exemplary power-save operating profile 200 illustrated in FIG. 2, the operation control module 560 may operate the portable communication system 500 at a fully functional performance level during time period t₄, and operate the portable communication system 500 in a sleep mode during time period t₅.

In another exemplary scenario, the operation control module 560 may operate the portable communication system 500 at a fully-functional and relatively high performance level in accordance with a first portion of the power-save operating profile, and operate the portable communication system 500 at a fully-functional and relatively low performance level in accordance with a second portion of the power-save operating profile. Referring to the exemplary power-save operating profile 200 illustrated in FIG. 2, the operation control module 560 may operate the portable communication system 500 at a fully functional and relatively high performance level during time period t₂, and operate the portable communication system 500 at a fully functional and relatively low performance level during time period t₀.

In yet another exemplary scenario, the operation control module 560 may (e.g., in conjunction with the power management unit 580) provide a supply of power with first power supply characteristics to one or more components of the portable communication system 500 in accordance with a first portion of the power-save operating profile, and provide a supply of power with second power supply characteristics to one or more components of the portable communication system 500 in accordance with a second portion of the power-save operating profile, the first and second power supply characteristics being different. Referring to the exemplary power-save operating profile 200 illustrated in FIG. 2, the operation control module 560 may provide a supply of power with first power supply characteristics to one or more components of the portable communication system 500 during time period t₀, and provide a supply of power with second power supply characteristics to one or more components of the portable communication system 500 during time period t₁.

In a further exemplary scenario, the operation control module 560 may (e.g., in conjunction with the clock module 570) provide a first clock signal to drive one or more components of the portable communication system 500 in accordance with a first portion of the power-save operating profile, and utilize a second clock signal to drive the one or more components in accordance with a second portion of the power-save operating profile, the first and second clock signals having different respective clock characteristics. Referring to the exemplary power-save operating profile 200 illustrated in FIG. 2, the operation control module 560 may provide a first clock signal to drive one or more components of the portable communication system 500 during time period t₀, and utilizing a second clock signal to drive the one or more components of the portable communication system during time period t₁.

In automatically operating the portable communication system 500 in accordance with the determined power-save operating profile, the operation control module 560 may also receive indications of various real-time events and/or conditions, and respond to such indications by adjusting the operating level of the portable communication system 500. Such real-time events and/or conditions may, for example and without limitation, comprise an input from a user, dynamic communication environmental conditions, an unexpected burst of usage during a typically low usage period, etc.

In automatically operating the portable communication system 500 in accordance with the determined power-save operating profile, the operation control module 560 may also receive operating instructions from a user (e.g., through the user interface module 555) and adjust the operating level of the portable communication system 500 based, at least in part, on such received operating instructions. For example and without limitation, a user may input operating instructions to mandate particular operating characteristics for a time period, thereby overriding the power-save operating profile. For example, a user may provide operating instructions to indicate that the portable communication system 500 is to operate at peak performance for a period of time or until the user specifies otherwise. The operation control module 560 may, for example, modify the operating level in accordance with such received operating instructions.

In automatically operating the portable communication system in accordance with the determined power-save operating profile, the operation control module 560 may also interact with various other operational control components of the portable communication system 500. For example and without limitation, the operation control module 560 may interact with various system components (e.g., a sleep module) that may generally control sleep mode operation of the portable communication system 500.

The operation control module 560 may control operation of the portable communication system 500 based, at least in part, on the power-save operating profile in any of a large variety of ways. The following discussion provides one non-limiting example of an exemplary operation control module 560 utilizing an exemplary power-save operating profile to control operation of the exemplary communication system 500. It is stressed that the following example is by no means to be construed as limiting the scope of various aspects of the present invention.

In the exemplary scenario, the operation control module 560 may determine a current time window of the power-save operating profile determined by the operating profile development module 550. For example, the operation control module 560 may determine the current time (e.g., current time of day, day, date, etc.) and determine a current time window of the power-save operating profile that corresponds to the current time.

The exemplary operation control module 560 may operate the portable communication system 500 in accordance with an operating level (and/or system operating characteristics) corresponding to the current time window. For example, the operation control module 560 may utilize the current time window determination to determine an operating level (and/or system operating characteristics) corresponding to the current time window. The operation control module 560 may then, for example, operate the portable communication system 500 in accordance with the determined operating level.

For example, an operating level may correspond to particular power-save operating characteristics (e.g., clock characteristics, power supply characteristics, sleep mode characteristics, etc.). The operation control module 560 may, for example, act in conjunction with other system 500 components (e.g., the clock module 570 and/or the power management unit 580) to operate the system 500 at the particular power-save operating characteristics.

Continuing the exemplary scenario, the exemplary operation control module 560 may determine if the end of the current time window has been reached. If the end of the current time window has been reached, then the operation control module 560 may determine the next time window of the power-save operating profile and continuing operation from there. If the end of the current time window has not been reached, then the operation control module 560 may wait for the end of the current time window to be reached.

For example and without limitation, as discussed previously, an exemplary power-save operating profile 200 is illustrated in FIG. 2. In an exemplary scenario, the operation control module 560 may determine that the current time is within the t₁ time window of the power-save operating profile 200. The operation control module 560 may determine that operating level 5 corresponds to the t₁ time window and may determine operating characteristics for the portable communication system 500 that correspond to operating level 5. For example, the operation control module 560 may determine that operating level 5 corresponds to the peak operating level for the portable communication system 500, where the peak operating level is characterized by maximum clock speed and optimal power supply characteristics for processing speed. The operation control module 560 may then comprise (e.g., in conjunction with the clock module 570 and/or power management unit 580) operating the portable communication system 500 according to the determined operating characteristics.

Continuing the exemplary scenario, the operation control module 560 may analyze the current time and the current time window until the current time no longer corresponds to the current time window. When the current time no longer corresponds to the current time window, the operation control module 560 may determine the next time window of the power-save operating profile, which in the exemplary illustration is t₂. The operation control module 560 may then, for example, analyze the power-save operating profile to determine that operating level 4 corresponds to time window t₂, and operate the portable communication system 500 in accordance with the operating characteristics associated with operating level 4. Such operation may continue until the operation control module 560 determines that the current time no long corresponds with time window t₂, and the operating cycle continues.

It should be noted that various modules of the exemplary portable communication system 500 may operate simultaneously or consecutively. For example and without limitation, various modules of the exemplary system 500 (e.g., the usage monitor module 540, the operating profile development module 550 and the operation control module 560) may operate simultaneously. Such simultaneity may, for example, be accomplished using independent processing circuitry and/or time-sharing a single processing circuit.

The exemplary system 500 illustrated in FIG. 5 and discussed previously is merely exemplary, and was presented to provide specific examples of various broader aspects of the present invention. Accordingly, the scope of various aspects of the present invention should not be limited by characteristics of the exemplary system 500 as discussed previously.

It should also be noted that various aspects of the present invention may be performed by hardware, a processor executing software instructions, or a combination thereof. Further, various aspects of the present invention may be performed by local modules or sub-systems or by a distributed network of modules or sub-systems. For example, various aspects of the present invention may be performed by modules integrated into a single integrated circuit. Accordingly, the scope of various aspects of the present invention should not be limited by characteristics of any particular implementation.

In summary, various aspects of the present invention provide a system and method for automatically controlling power save operation in a portable communication system utilizing historical usage information.

While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method for automatically controlling power-save operation of a portable communication system, the method comprising:
monitoring usage of the portable communication system;
accumulating usage information for the portable communication system;
determining a communication system power-save operating profile based, at least in part, on the accumulated usage information; and
automatically operating the portable communication system in accordance with the determined power-save operating profile.

2. The method of claim 1, wherein the usage information comprises time information.

3. The method of claim 1, wherein the usage information comprises day information.

4. The method of claim 1, wherein the usage information comprises performance level information.

5. The method of claim 1, wherein the power-save operating profile comprises power-save operating level information and time information.

6. The method of claim 1, wherein the power-save operating profile comprises power-save operating level information and day information.

7. The method of claim 1, wherein the power-save operating profile comprises information of a plurality of fully functional power-save operating levels.

8. The method of claim 1, wherein automatically operating the portable communication system in accordance with the determined power-save operating profile comprises operating the portable communication system at a relatively high performance level in accordance with a first portion of the power-save operating profile, and operating the portable communication system at a relatively low performance level in accordance with a second portion of the power-save operating profile.

9. The method of claim 1, wherein automatically operating the portable communication system in accordance with the determined power-save operating profile comprises operating the portable communication system at a fully functional performance level in accordance with a first portion of the power-save operating profile, and operating the portable communication system in a sleep mode in accordance with a second portion of the power-save operating profile.

10. The method of claim 1, wherein automatically operating the portable communication system in accordance with the determined power-save operating profile comprises operating the portable communication system at a fully functional and relatively high performance level in accordance with a first portion of the power-save operating profile, and operating the portable communication system at a fully functional and relatively low performance level in accordance with a second portion of the power-save operating profile.

11. The method of claim 1, wherein automatically operating the portable communication system in accordance with the determined power-save operating profile comprises providing a supply of power with first power supply characteristics to a component of the portable communication system in accordance with a first portion of the power-save operating profile, and providing a supply of power with second power supply characteristics to the component of the portable communication system in accordance with a second portion of the power-save operating profile, the first and second power supply characteristics being different.

12. The method of claim 1, wherein automatically operating the portable communication system in accordance with the determined power-save operating profile comprises utilizing a first clock signal to drive a component of the portable communication system in accordance with a first portion of the power-save operating profile, and utilizing a second clock signal to drive the component of the portable communication system in accordance with a second portion of the power-save operating profile, the first and second clock signals having different respective clock rates.

13. The method of claim 1, wherein automatically operating the portable communication system in accordance with the determined power-save operating profile comprises adjusting operating characteristics of the portable communication system in response to real-time events.

14. The method of claim 1, further comprising receiving operating instructions from a user and operating the portable communication system in accordance with the operating instructions.

15. The method of claim 1, wherein the portable communication system comprises a cellular phone.

16. A system for automatically controlling power-save operation of a portable communication system, the system comprising:
a usage information database;
a first module that monitors usage of the portable communication system, and stores portable communication system usage information in the usage information database;
a second module that processes the portable communication system usage information to determine a power-save operating profile; and
a third module that controls operation of the portable communication system based, at least in part, on the power-save operating profile.

17. The system of claim 16, wherein:
the first module comprises a usage monitor module;
the second module comprises an operating profile development module; and
the third module comprises an operation control module.

18. The system of claim 16, wherein the usage information comprises time information.

19. The system of claim 16, wherein the usage information comprises day information.

20. The system of claim 16, wherein the usage information comprises performance level information.

21. The system of claim 16, wherein the power-save operating profile comprises power-save operating level information and time information.

22. The system of claim 16, wherein the power-save operating profile comprises power-save operating level information and day information.

23. The system of claim 16, wherein the power-save operating profile comprises information of a plurality of fully functional operating levels.

24. The system of claim 16, wherein the third module operates the portable communication system at a relatively high performance level in accordance with a first portion of the power-save operating profile, and operates the portable communication system at a relatively low performance level in accordance with a second portion of the power-save operating profile.

25. The system of claim 16, wherein the third module operates the portable communication system at a fully functional performance level in accordance with a first portion of the power-save operating profile, and operates the portable communication system in a sleep mode in accordance with a second portion of the power-save operating profile.

26. The system of claim 16, wherein the third module operates the portable communication system at a fully functional and relatively high performance level in accordance with a first portion of the power-save operating profile, and operates the portable communication system at a fully functional and relatively low performance level in accordance with a second portion of the power-save operating profile.

27. The system of claim 16, further comprising a power management unit, and wherein the third module directs the power management unit to provide a supply of power with first power supply characteristics to a component of the portable communication system in accordance with a first portion of the power-save operating profile, and to provide a supply of power with second power supply characteristics to the component of the portable communication system in accordance with a second portion of the power-save operating profile, the first and second power supply characteristics being different.

28. The system of claim 16, further comprising a clock module, and wherein the third module directs the clock module to provide a first clock signal to drive a component of the portable communication system in accordance with a first portion of the power-save operating profile, and to provide a second clock signal to drive the component of the portable communication system in accordance with a second portion of the power-save operating profile, the first and second clock signals having different respective clock rates.

29. The system of claim 16, wherein the third module adjusts operating characteristics of the portable communication system in response to real-time events.

30. The system of claim 16, further comprising a user interface module that receives operating instructions from a user, and wherein the third module operates the portable communication system in accordance with the operating instructions.

31. The system of claim 16, wherein the portable communication system comprises a cellular phone.
